(19) United States
(12) Patent Application Publication
(10) Pub. No.: US 2026/0276028 A1
(43) Pub. Date: Sep. 17, 2026

(54) Arrangement for Connecting Components

(71) Applicant: Nord-Lock International AB, Mattmar (SE)

(72) Inventors: Martin Klein, Aalen (DE); Andreas Maile, Lauchheim (DE)

(21) Appl. No.: 19/469,954

(22) PCT Filed: Mar. 28, 2024
(86) PCT No.: PCT/EP2024/058467

§ 371 Date: Sep. 26, 2025

(30) Foreign Application Priority Data
Mar. 28, 2023 (DE) 10 2023 107 759.7

(51) Int. Cl. F16B 39/24; F16B 11/00; F16B 39/282

(52) U.S. Cl. CPC F16B 39/24; F16B 11/006; F16B 39/282

(57) ABSTRACT

An arrangement for connecting components comprises a screw bolt and a pair of wedge lock washers having at least two wedge lock washers with respective recesses for the passage of the screw bolt. An adhesive is located in an annular gap formed between the pair of wedge lock washers and the screw bolt inserted into the recess of the wedge lock washers.

The invention relates to an arrangement for connecting components, comprising a screw bolt and a pair of wedge lock washers having at least two wedge lock washers with respective recesses for the passage of the screw bolt. Furthermore, the invention relates to a method for manufacturing such an arrangement and to an apparatus for carrying out this method.

DE 20 2019 106 592 U 1 discloses a screw fastening means comprising a screw bolt and a pair of wedge lock washers connected thereto. The pair of wedge lock washers is adhesively connected to the contact surface of the screw bolt with its side facing the contact surface of the screw bolt.

### SHORT DESCRIPTION OF THE INVENTION

However, a disadvantage of this arrangement is that even partial volatilisation of the adhesive can result in settlements between the pair of wedge lock washers and the screw bolt, which can lead to a reduction in the pretensioning force and thus ultimately to loosening of the screw connection formed by means of this arrangement. Furthermore, the adhesive can impair the imprinting of the radial ribs of the wedge lock washers into the screw head and thus prevent the basic function of the pair of wedge lock washers, namely a complete form fit. The application of the adhesive is also comparatively complex, which can lead to higher costs in the manufacture of the screw fastening means described therein.

It is therefore an object of the present invention to provide an arrangement for connecting components comprising a screw bolt and a pair of wedge lock washers, which is simple to manufacture, ensures a secure function of the pair of wedge lock washers and simplifies the use of such an arrangement comprising a screw bolt and a pair of wedge lock washers.

According to the invention, this object is solved by the features mentioned in claim 1.

In the arrangement according to the invention, there is an adhesive located in an annular gap which is formed between the pair of wedge lock washers and the screw bolt which is passed through the recess thereof, which adhesive ensures a reliable connection between the pair of wedge lock washers and the screw bolt which is sufficient for the application of the arrangement according to the invention. The adhesive serves only for a temporary connection between the screw bolt and the pair of wedge lock washers in order to be able to handle these two parts together. The adhesive does not play a role in the subsequent use of the arrangement according to the invention for connecting components to each other.

This way, a loss-proof attachment of the pair of wedge lock washers to the screw bolt is obtained in such a way that a user can save the step of passing the screw bolt through the recess of the pair of wedge lock washers. Especially in places that are difficult to access or at greater heights, such a pre-assembled arrangement is of great advantage and offers a high level of work safety compared to known solutions. The handling of the arrangement according to the invention consisting of the screw bolt and the pair of wedge lock washers can also be automated.

The solution according to the invention allows the adhesive to be applied very finely in the annular gap, so that any interference with the actual functioning of the arrangement formed by the screw bolt and the pair of wedge lock washers can be reliably prevented.

With the arrangement formed according to the present invention, almost any shape of bolt can be connected to any shape of a pair of wedge lock washers. The arrangement according to the invention thus represents an assembly aid suitable for a wide variety of purposes.

A reliable connection of the wedge lock washers of the pair of wedge lock washers results if, in a very advantageous further development of the invention, an adhesive is located between the two wedge lock washers of the pair of wedge lock washers.

Furthermore, it can be provided that the adhesive located between the wedge lock washers is the same as the adhesive located in the annular gap. This way, the manufacture of the arrangement according to the invention can be substantially simplified, since one and the same adhesive can be used both for connecting the wedge lock washers and for connecting the pair of wedge lock washers to the screw bolt. By using one and the same adhesive, no additional testing or approval of the same is necessary.

In practice, it has proven to be particularly advantageous, if the adhesive is Henkel® National 281 E.

A further advantageous embodiment of the invention can be that the screw bolt has a screw bolt head and a screw bolt shaft, the screw bolt shaft having a thread extending up to the screw bolt head. This results in a particularly good connection between the pair of wedge lock washers and the screw bolt by means of the adhesive arranged in the annular gap, which connects particularly well with the thread of the screw bolt shaft.

In claim 6 a method of manufacturing an assembly according to the invention is stated.

In this method, the adhesive is dispensed from an adhesive dispenser into the annular gap, the bolt being rotated during the dispensing of the adhesive.

The method according to the invention can be carried out very easily and offers a very high process reliability. Furthermore, the process can be applied very quickly and flexibly even with small batch sizes. A particular advantage of the process according to the invention is that it can be automated very easily.

A further simplification of the process according to the invention can result if, in an advantageous embodiment thereof, the adhesive dispenser is moved towards the screw bolt by means of a traversing device.

An apparatus for carrying out the method is stated in claim 8.

This apparatus comprises an adhesive dispenser and a rotation device for rotating the screw bolt. The apparatus can be manufactured very simply and offers a high level of process reliability when carrying out the method.

If a traversing device is provided for moving the adhesive dispenser in the direction of the screw bolt, the adhesive dispenser can be moved very easily in the direction of the screw bolt and also back to a rest position in order to remove the assembly of the screw bolt and the pair of wedge lock washers produced by the method.

In the following, an embodiment of the invention is illustrated in principle with reference to the drawing.

### In the Drawings:

FIG. 1 is a side view of the arrangement according to the invention;

FIG. 2 is a view of the arrangement according to arrow II in FIG. 1;

FIG. 3 is a device according to the invention for carrying out the method according to the invention in a first position; and

FIG. 4 is the device from FIG. 3 in a second position.

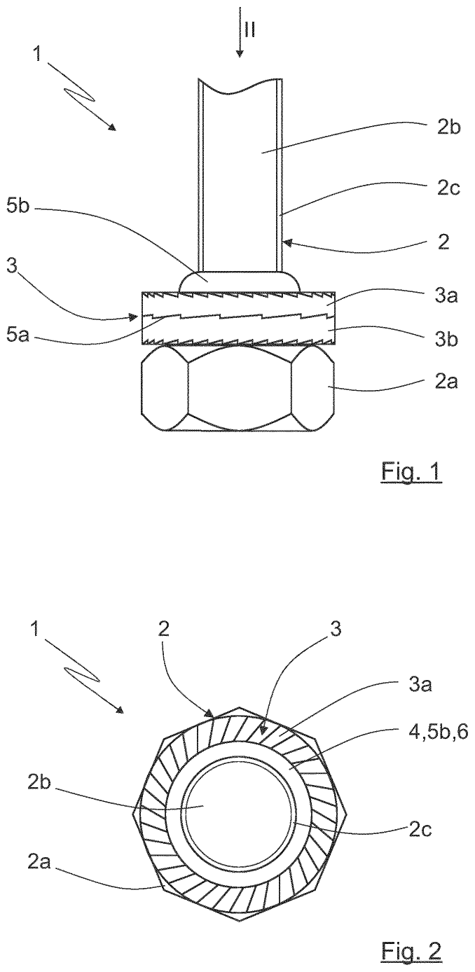

FIG. 1 shows an arrangement 1 for connecting components not shown in the figures. The arrangement 1 comprises a screw bolt 2 and a pair of wedge lock washers 3. In a manner known per se, the pair of wedge lock washers 3 in turn comprises two wedge lock washers 3a and 3b, which each have through recesses 4 for the screw bolt 2 to pass through. This basic construction of the arrangement 1 is known from the prior art. The basic operation of the pair of wedge lock washers 3 is also known from the prior art, which is why it will not be discussed in more detail herein.

In the present case, the screw bolt 2 has a screw bolt head 2a and a screw bolt shaft 2b. The screw bolt shaft 2b has a thread 2c extending from its tip to the screw bolt head 2a.

In order to connect the two wedge lock washers 3a and 3b to each other in a captive manner, there is an adhesive 5a between them. Furthermore, an adhesive 5b is located in an annular gap 6 formed between the pair of wedge lock washers 3 and the screw bolt 2 inserted into the recess 4 of the wedge lock washers 3a, 3b.

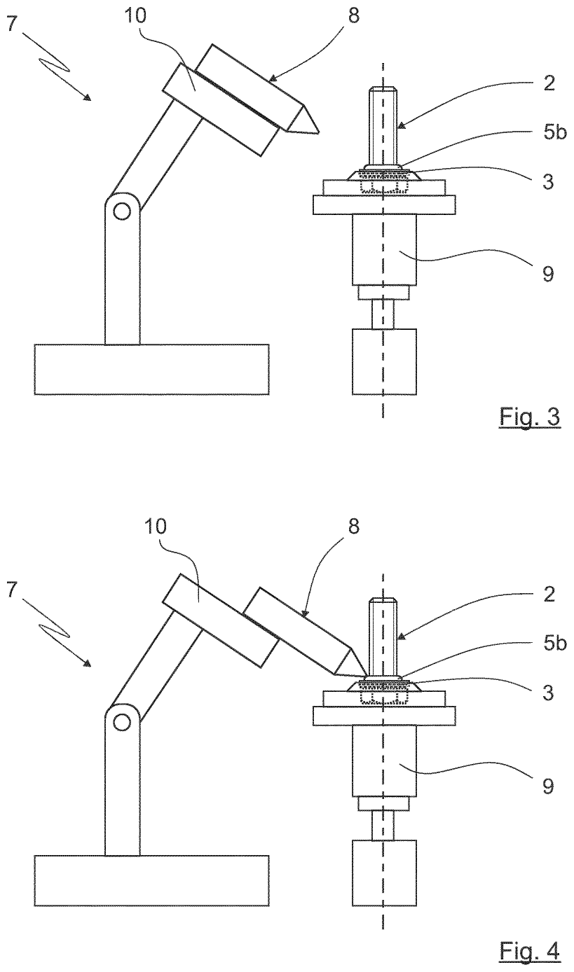

Preferably, the adhesive 5a between the wedge lock washers 3a, 3b and the adhesive 5b in the annular gap 6 are identical. In this case, the adhesive Henkel® National 281 E is preferably used. However, it is also possible to use different adhesives for the adhesive 5a and the adhesive 5b. The choice of the adhesive may depend, among other things, on the use of the arrangement 1 by a user of the same. FIGS. 3 and 4 show in a very schematic manner an apparatus 7 for carrying out a method of manufacturing the arrangement 1 shown in FIGS. 1 and 2 in two different positions, a rest position of the apparatus 7 being shown in FIG. 3.

The apparatus 7 has an adhesive dispenser 8, a rotation device 9 and a traversing device 10. In the method of manufacturing the arrangement 1 carried out with the apparatus 7, the adhesive 5b is dispensed from the adhesive dispenser 8 into the annular gap 6. During this dispensing of the adhesive 5b, the screw bolt 2 is rotated by means of the rotation device 9 in such a way that the adhesive 5b enters the annular gap 6 around its entire circumference. The adhesive dispenser 8 is arranged on the traversing device 10 and can be moved with the same towards the screw bolt 2, as shown in the working position of FIG. 4. For this purpose, the traversing device 10 can, for example, have a pneumatic cylinder. However, any other device capable of producing a desired movement of the adhesive dispenser 8 is also suitable.

The screw bolt 2 with the pair of wedge lock washers 3 arranged on the screw bolt shaft 2b can be fed to the rotation device 9 by means of a feeding device not shown, for example in the form of a handling robot.

The adhesive 5a located between the two wedge lock washers 3a and 3b of the pair of wedge lock washers 3 can be applied or inserted in a manner not shown before the screw bolt 2 is inserted into the recess 4 of the wedge lock washers 3a and 3b.

1. An arrangement for connecting components, comprising a screw bolt and a pair of wedge lock washers having at least two wedge lock washers with respective recesses for the passage of the screw bolt, wherein
an adhesive is located in an annular gap formed between the pair of wedge lock washers and the screw bolt inserted into the recess of the wedge lock washers.

2. The arrangement according to claim 1, wherein
an adhesive is located between the two wedge lock washers of the pair of wedge lock washers.

3. The arrangement according to claim 2, wherein
the adhesive located between the wedge lock washers is the same as the adhesive located in the annular gap.

4. The arrangement according to claim 3, wherein
the adhesive is Henkel® National 281 E.

5. The arrangement according to claim 1, wherein
the screw bolt has a screw bolt head and a screw bolt shaft, the screw bolt shaft having a thread extending up to the screw bolt head.

6. A method of manufacturing an arrangement according to any claim 1, wherein the adhesive is dispensed into the annular gap from an adhesive dispenser and wherein during the dispensing of the adhesive the screw bolt is rotated.

7. The method according to claim 6, wherein
the adhesive dispenser is moved towards the screw bolt by means of a traversing device.

8. The apparatus for carrying out the method according to claim having an adhesive dispenser and having a rotation device for rotating the screw bolt.

9. The apparatus according to claim 8, comprising a traversing device for moving the adhesive dispenser in the direction of the screw bolt.
